(19) United States
(12) Patent Application Publication
(10) Pub. No.: US 2013/0168168 A1
(43) Pub. Date: Jul. 4, 2013

(54) Hybrid Vehicle

(71) Applicant: Izumi Takagi, Akashi-shi (JP)

(72) Inventor: Izumi Takagi, Akashi-shi (JP)

(73) Assignee: KAWASAKI JUKOGYO KABUSHIKI KAISHA, Kobe-shi (JP)

(21) Appl. No.: 13/339,320

(22) Filed: Dec. 28, 2011

(51) Int. Cl. B60K 6/22; B60K 6/20

(52) U.S. Cl. 180/65.245; 180/65.21; 903/903

(57) ABSTRACT

A hybrid vehicle is provided. The hybrid vehicle may comprise a vehicle body frame; a metal-made heat radiation plate having a flat plate portion of a substantially plate shape, the flat plate portion having obverse and reverse flat surfaces; a first electric component provided on one of the obverse and reverse flat surfaces of the flat plate portion. Further, the surface of the flat plate portion on which the first electric component is provided is greater in area than an electric component mounting section to which the first electric component is mounted.

### BACKGROUND OF THE INVENTION

1. Field of the Invention

The present invention relates to a hybrid vehicle including electric components which generate heat when they are activated.

2. Description of the Related Art

Japanese Laid-Open Patent Application Publication No. 2006-198048 discloses an electric golf cart including a driving motor actuated by electric power supplied from a battery, an electric generator for charging the battery, a motor controller for controlling the driving motor, and a CPU for power generation control for controlling the electric generator. In this electric golf cart, a substantially-rod-shaped frame mounted to a vehicle body frame to extend laterally is provided with a motor controller mounting section, and a motor controller is secured to the motor controller mounting section. The lower surface of the motor controller is a heat radiation plate exposed below a floor surface. Because of this structure, the motor controller is cooled merely by heat exchange between the lower surface of the motor controller and outside air. Under these conditions, the motor controller is not cooled effectively.

### SUMMARY OF THE INVENTION

The present invention addresses the above described condition, and an object of the present invention is to cool electric components generating heat more effectively.

A hybrid vehicle of the present invention comprises a vehicle body frame; a metal-made heat radiation plate having a flat plate portion of a substantially plate shape, the flat plate portion having obverse and reverse flat surfaces; a first electric component provided on one of the obverse and reverse flat surfaces of the flat plate portion; and the surface of the flat plate portion on which the first electric component is provided, is greater in area than an electric component mounting section to which the first electric component is mounted.

In such a configuration, since the first electric component is provided on the surface of the flat plate portion, heat generated in the first electric component can be transferred from the flat plate portion to the entire heat radiation plate and stored therein. Since the surface of the flat plate portion is greater in area than the electric component mounting section to which the first electric component is mounted, the heat stored in the flat plate portion can be radiated efficiently from the large-area surface of the flat plate portion. Since the surface of the flat plate portion is flat, air is less likely to get stagnant in the vicinity of the flat plate portion and mud or the like is less likely to adhere to dented portion of the flat plate portion, as compared to a heat radiation plate provided with a plurality of fins.

The above and further objects, features and advantages of the invention will more fully be apparent from the following detailed description with reference to the accompanying drawings.

### BRIEF DESCRIPTION OF THE DRAWINGS

FIG. 1 is a perspective view showing an external appearance of a hybrid vehicle according to an embodiment, when viewed from obliquely above.

FIG. 2 is a plan view of the hybrid vehicle according to the embodiment, showing a state where a seat and a cargo bed are detached from the hybrid vehicle.

FIG. 3 is a perspective view showing a configuration of a vehicle body frame, and a battery unit in the hybrid vehicle according to the embodiment, when viewed from obliquely above.

FIG. 4 is a perspective view of the hybrid vehicle according to the embodiment, showing a state where the cargo bed is detached from the hybrid vehicle, when viewed from obliquely above.

FIG. 5 is a view showing the layout of electric wires in the hybrid vehicle according to the embodiment.

FIG. 6 is an exploded perspective view of a heat radiation plate, a front wheel drive motor controller (electric component), a rear wheel drive motor controller (electric component), and an electric generator controller (electric component), when viewed from obliquely above.

FIG. 7 is a perspective view of the heat radiation plate, the front wheel drive motor controller (electric component), and the rear wheel drive motor controller (electric component), when viewed from obliquely above.

FIG. 8 is a right side view showing an external appearance of the electric generator controller (electric component) mounted to the heat radiation plate.

FIG. 9 is a cross-sectional view showing a coupling mechanism for coupling the heat radiation plate to the vehicle body frame.

### DETAILED DESCRIPTION OF THE PREFERRED EMBODIMENTS

Hereinafter, an embodiment of the present invention will be described with reference to the drawings. The stated directions are referenced from the perspective of a driver riding in a hybrid vehicle. A rightward and leftward direction conforms to a vehicle width direction. It is supposed that the hybrid vehicle is in a stopped state on a ground surface which is substantially parallel to a horizontal plane.

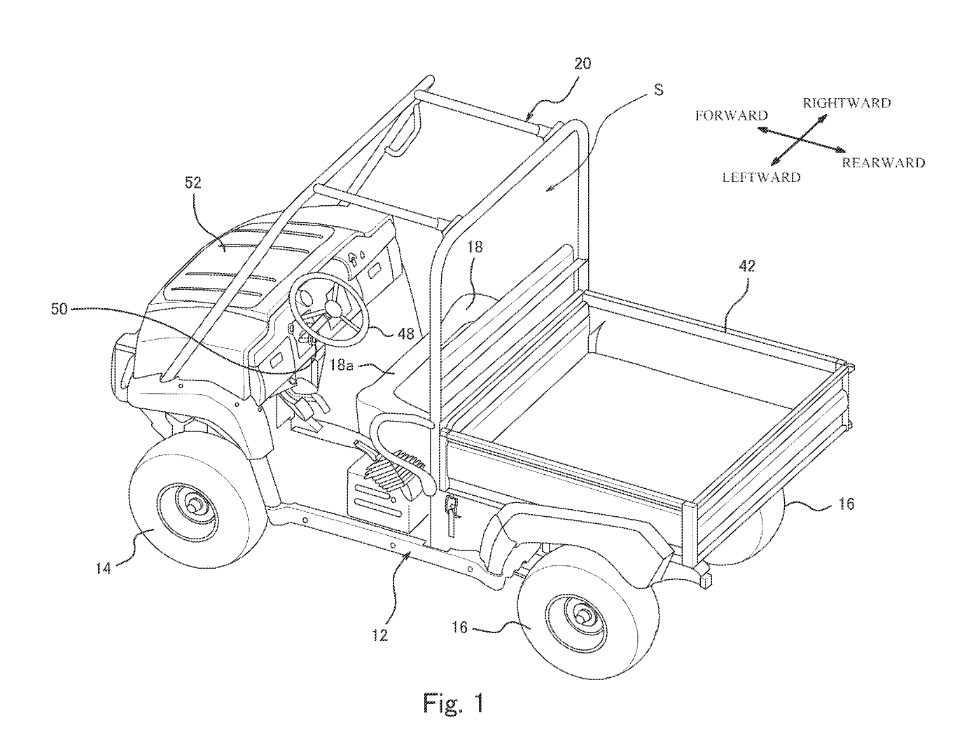

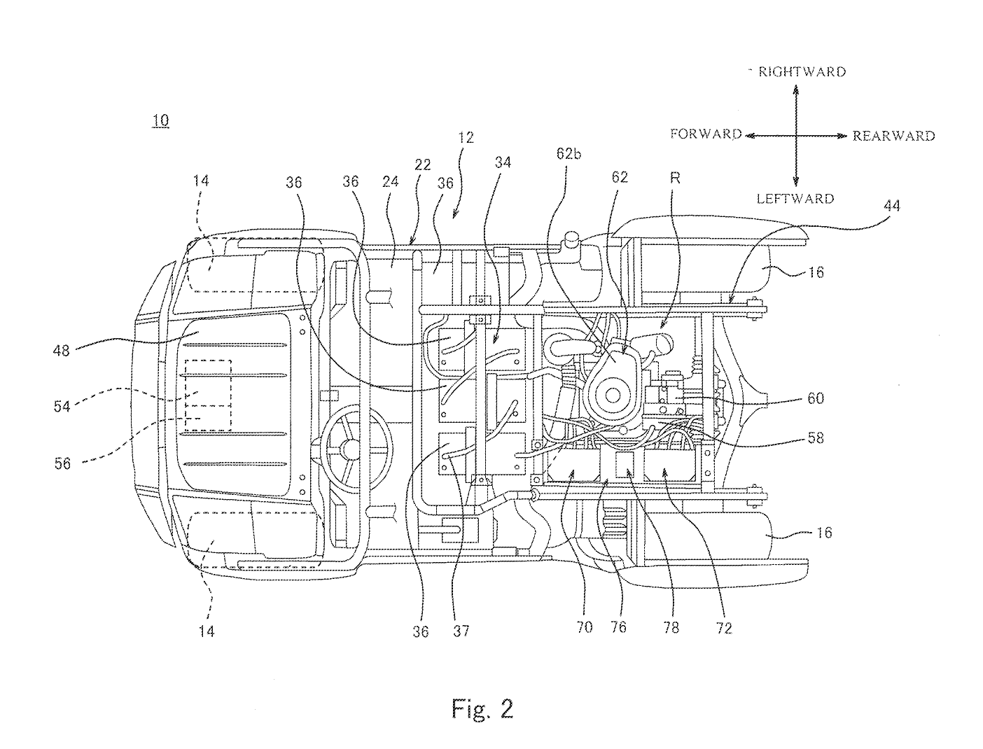

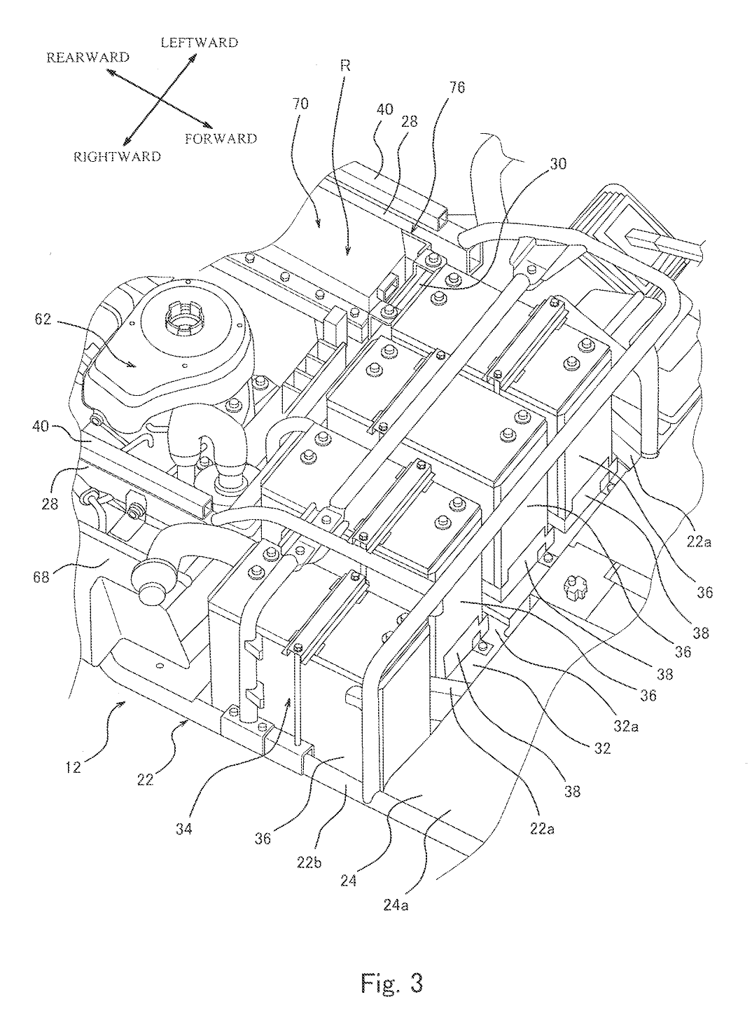

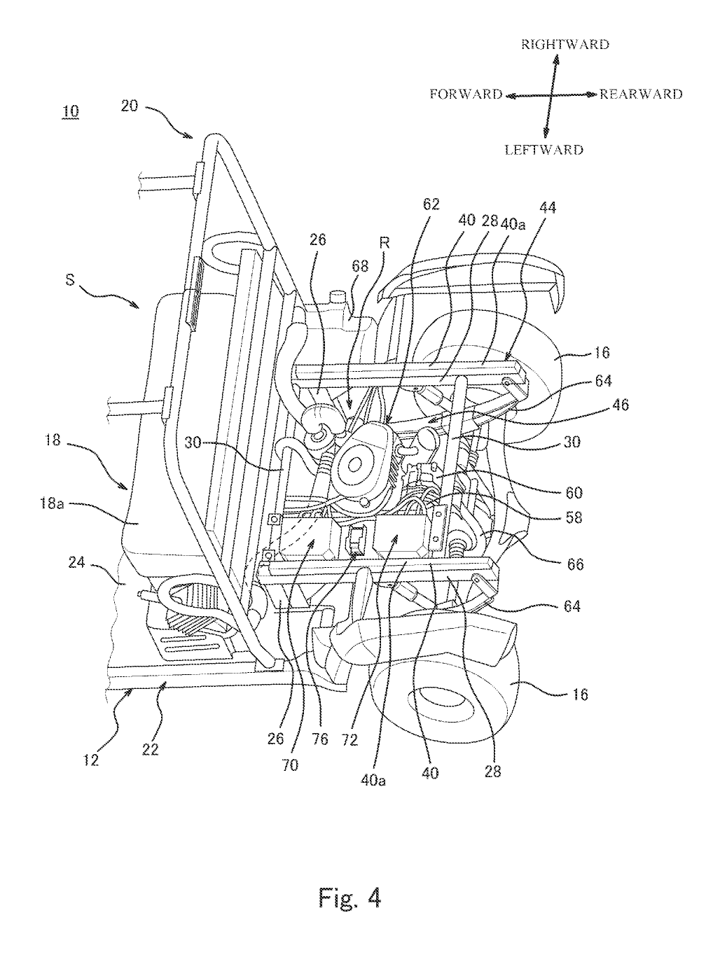

FIG. 1 is a perspective view showing an external appearance of a hybrid vehicle 10 according to an embodiment, when viewed from obliquely above. FIG. 2 is a plan view of the hybrid vehicle 10 according to the embodiment, showing a state where a seat 18 (FIG. 1) and a cargo bed 42 (FIG. 1) are detached from the hybrid vehicle 10. FIG. 3 is a perspective view showing a configuration of a vehicle body frame 12, and a battery unit 34 in the hybrid vehicle 10, when viewed from obliquely above. FIG. 4 is a perspective view of the hybrid vehicle 10, showing a state where the cargo bed 42 (FIG. 1) is detached from the hybrid vehicle 10, when viewed from obliquely above. In the present embodiment, the hybrid vehicle 10 may be used in various ways, for example, as a golf cart, or a farming truck, and is sometimes referred to as a utility vehicle.

As shown in FIG. 1, the hybrid vehicle 10 includes the vehicle body frame 12, a pair of right and left front wheels 14 suspended from the front portion of the vehicle body frame 12, a pair of right and left rear wheels 16 suspended from the rear portion of the vehicle body frame 12, a bench seat 18 provided in the center portion of the vehicle body frame 12 in a forward and rearward direction (lengthwise direction of the hybrid vehicle 10) to extend in the vehicle width direction, and a cabin frame 20 surrounding the seat 18. A cabin space S is defined as a region where the seat 18 is disposed, inwardly relative to the cabin frame 20.

As shown in FIGS. 2˜4, the vehicle body frame 12 includes a main frame 22 placed to face the road surface or the ground surface. As shown in FIG. 4, the vehicle body frame 12 includes a pair of right and left rear side frames 28 coupled to the rear portion of the main frame 22 via coupling members 26 and extending in the forward and rearward direction, and two cross members 30 provided between and coupled to the rear side frames 28.

As shown in FIG. 3, the main frame 22 includes a plurality of square pipes 22a each having a substantially rectangular cross-section and a plurality of round pipes 22b each having a substantially circular cross-section. The square pipes 22a and the round pipes 22b are joined together. A floor panel 24 is mounted to a portion of the main frame 22, constituting the floor of the cabin space S (FIG. 1), while battery support plates 32 are mounted to a portion of the main frame 22, which is below the seat 18 (FIG. 1). The floor panel 24 is a member having a substantially plate shape and constitutes the floor surface of the cabin space S (FIG. 1). An upper surface 24a of the floor panel 24 is substantially as high as or higher than a highest point of the square pipes 22a and a highest point of the round pipes 22b. The battery support plates 32 are substantially-plate-shaped members for supporting the batteries 36, respectively, and an upper surface 32a of each of the battery support plates 32 is positioned below the highest point of the square pipes 22a and the highest point of the round pipes 22b. The plurality of batteries 36 (in the present embodiment, four) are mounted to upper surfaces 32a of the battery support plates 32 via battery holders 38, respectively.

As shown in FIG. 4, the coupling members 26 are members of a substantially plate shape extending vertically. The lower end portion of each of the coupling members 26 is coupled to the main frame 22, while the upper end portion of each of the coupling members 26 is coupled to the front end portion of the corresponding rear side frame 28. Therefore, the rear side frame 28 is positioned higher than the main frame 22 by a length of the coupling member 26, and the distance from the road surface or the ground surface to the rear side frame 28 is greater than the distance from the road surface or the ground surface to the main frame 22. The rear side frame 28 is a pipe member having a substantially rectangular cross-section. A cargo bed support member 40 of a pipe shape having a substantially rectangular cross-section is coupled to the upper surface of the corresponding rear side frame 28. The rear side frame 28 and the cargo bed support member 40 may have a unitary pipe shape.

As shown in FIG. 4, the two rear side frames 28 are arranged substantially in parallel to be apart from each other in the vehicle width direction. The two rear side frames 28 are coupled together by means of two cross members 30 extending in the vehicle width direction. In this structure, a frame member 44 of a substantially rectangular shape when viewed from above is provided in the rear portion of the vehicle body frame 12. A space within the frame member 44 is an engine room R in which a rear wheel drive motor 58, an engine electric generator 62, and others are arranged. As shown in FIG. 1, the cargo bed 42 is mounted to cover an opening 46 (FIG. 4) of the engine room R.

As shown in FIG. 1, the cargo bed 42 is constituted by a plurality of steel plates joined together in a rectangular shape. The bottom portion of the cargo bed 42 is in contact with the upper surfaces of cargo bed support members 40 (FIG. 4). The rear portion of the cargo bed 42 is coupled to the frame member 44 (FIG. 4) via a rotary shaft (not shown) extending in the vehicle width direction such that the cargo bed 42 is pivotable. As shown in FIG. 4, when maintenance of the devices and components laid out in the engine room R is carried out, the opening 46 of the engine room R can be opened by pivoting the cargo bed (FIG. 1) in an upward direction.

As shown in FIG. 1, the seat 18 has a length for allowing two passengers to be seated thereon side by side in the vehicle width direction. A portion of the seat 18 which is located leftward relative to the center portion in the vehicle width direction is a driver seat 18a on which the driver can be seated. A handle 48 is provided in front of the driver seat 18a, and a key switch 50 which is operated by the driver to start the hybrid vehicle 10 is provided in the vicinity of the handle 48. A hood 52 is mounted to a portion of the vehicle body frame 12 which is forward relative to the cabin space S. The engine room R (FIG. 4) and the cargo bed 42 are positioned behind the driver seat 18a.

Referring to FIG. 2, the hybrid vehicle 10 includes a front wheel drive motor 54 for driving the front wheels 14, a driving power transmission mechanism 56 for transmitting the driving power generated in the front wheel drive motor 54 to the front wheels 14, a rear wheel drive motor 58 for driving the rear wheels 16, a driving power transmission mechanism 60 for transmitting the driving power generated in the rear wheel drive motor 58 to the rear wheels 16, an engine electric generator 62, and the battery unit 34 including the plurality of batteries 36. In the present embodiment, the hybrid vehicle 10 is a series-hybrid vehicle, and the plurality of batteries 36 of the battery unit 34 are charged with the electric power generated by the engine electric generator 62, and the front wheel drive motor 54 and the rear wheel drive motor 58 are actuated by the electric power supplied from the battery unit 34.

As shown in FIG. 2, the front wheels 14 are suspended from both side portions of the front portion of the main frame 22 in the vehicle width direction via suspension devices (not shown), and the front wheel drive motor 54 and the driving power transmission mechanism 56 are arranged at the center portion of the front portion of the main frame 22 in the vehicle width direction. As shown in FIG. 4, the rear wheels 16 are suspended from both side portions of the frame member 44 in the vehicle width direction via suspension devices 64, and the rear wheel drive motor 58, the driving power transmission mechanism 60 and the engine electric generator 62 are arranged in the engine room R. As shown in FIG. 2, the battery unit 34 is positioned at the center portion of the vehicle body frame 12 in the forward and rearward direction. As shown in FIG. 3, each of the plurality of batteries 36 constituting the battery unit 34 is mounted to the upper surface 32a of the battery support plate 32 via the battery holder 38. As shown in FIG. 2, the plurality of batteries 36 are interconnected via electric wires 37. In this way, the battery unit 34 can have a required voltage (e.g., 48V) and a required capacity.

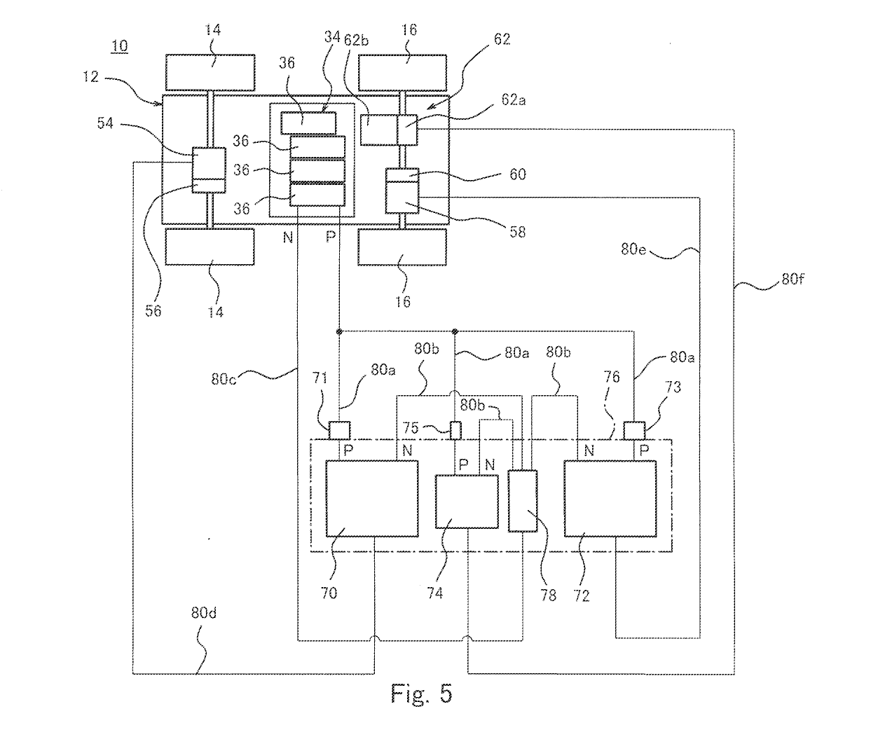

FIG. 5 is a view showing the layout of electric wires in the hybrid vehicle 10. As shown in FIG. 5, the engine electric generator 62 includes an electric generator 62a and an engine 62b for actuating the electric generator 62a. The electric generator 62a acts as an electric generator for generating AC power charged into the batteries 36, or as a starter for starting the engine 62b. In the present embodiment, the engine 62b is a single-cylinder reciprocating engine, and has a crankshaft (not shown) extending vertically. The electric generator 62a is mounted to the lower portion of a crankcase (not shown) accommodating the lower end portion of the crankshaft.

As shown in FIG. 4, the engine electric generator 62, the rear wheel drive motor 58 and the driving power transmission mechanism 60 are mounted to a sub-frame 66 mounted to the main frame 22 and to the frame member 44. The engine 62b (FIG. 5) of the engine electric generator 62 is positioned rightward relative to the center portion of the vehicle body frame 12 in the vehicle width direction. A fuel tank 68 for storing a fuel supplied to the engine 62b is positioned in a right side portion of the vehicle body frame 12. That is, the engine 62b and the fuel tank 68 are positioned at an opposite side of the driver seat 18a in the vehicle width direction. Because of this layout, a good weight balance in the vehicle width direction can be maintained in the hybrid vehicle 10.

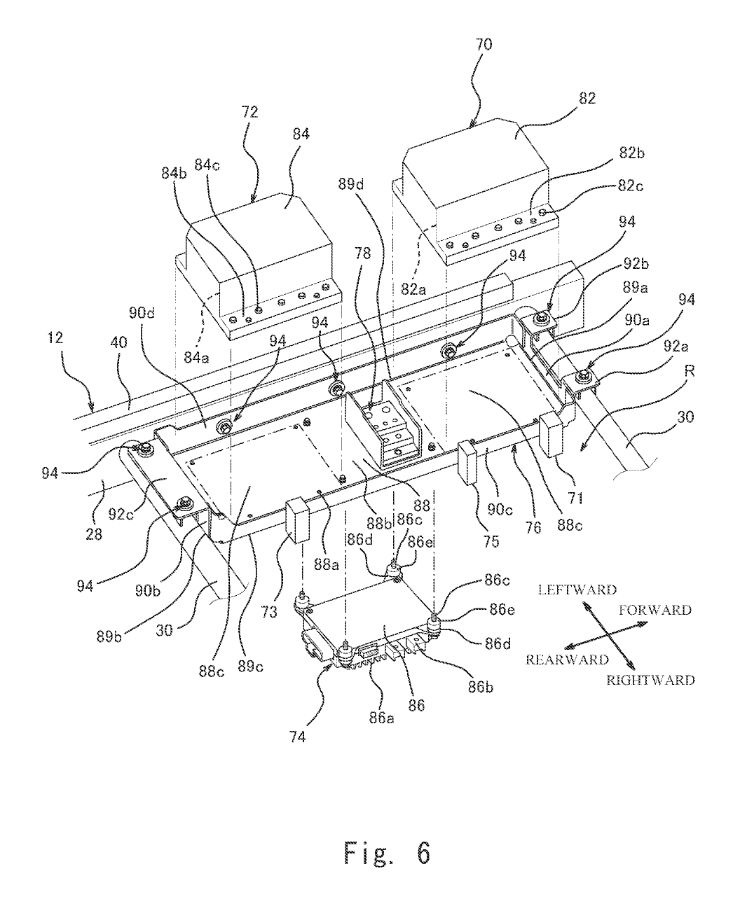

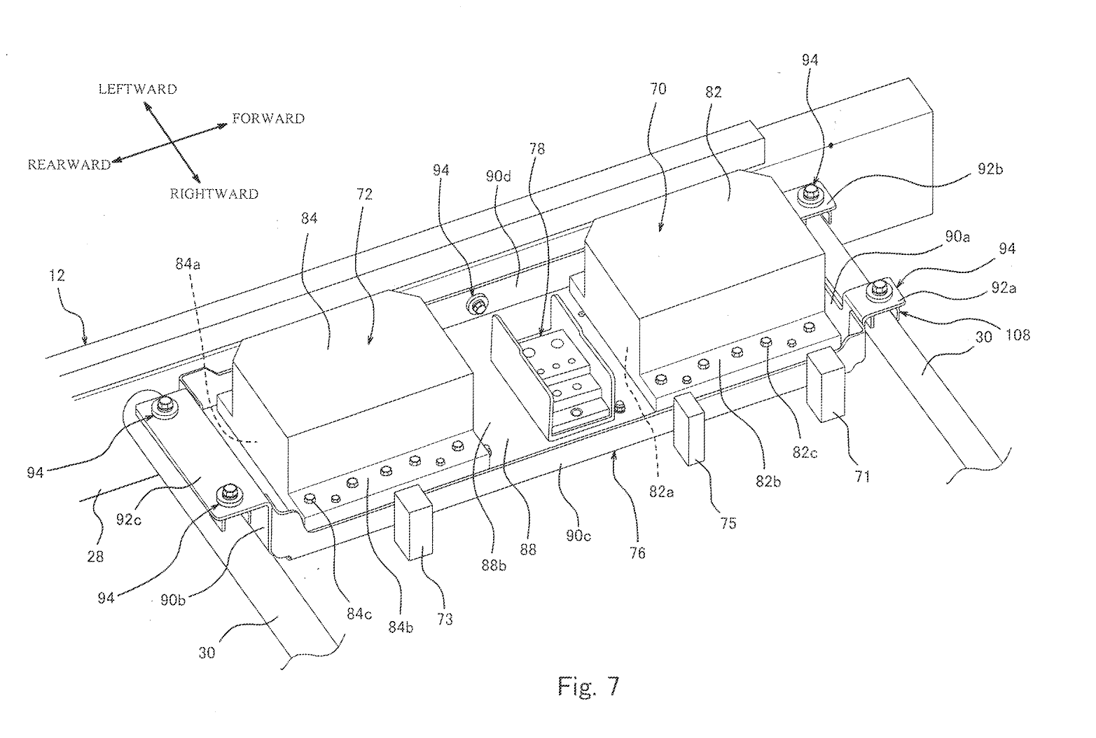

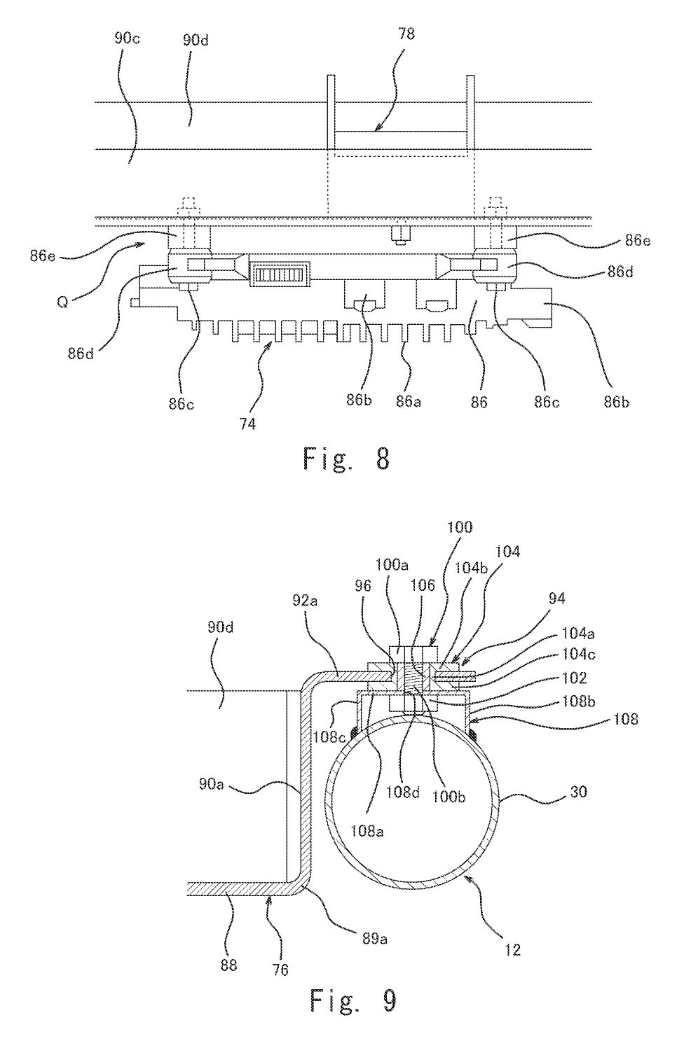

FIG. 6 is an exploded perspective view of the heat radiation plate 76, the front wheel drive motor controller 70, the rear wheel drive motor controller 72, and the electric generator controller 74, when viewed from obliquely above. FIG. 7 is a perspective view of these electric components, when viewed from obliquely above. FIG. 8 is a right side view showing an external appearance of the electric generator controller 74 mounted to the heat radiation plate 76. The front wheel drive motor controller 70, the rear wheel drive motor controller 72, and the electric generator controller 74, are electric components generating heat when they are activated.

As shown in FIG. 5, the hybrid vehicle 10 includes a front wheel drive motor controller 70 for controlling electric power supply to the front wheel drive motor 54, a rear wheel drive motor controller 72 for controlling electric power supply to the rear wheel drive motor 58, an electric generator controller 74 for controlling electric power supply to the engine electric generator 62, and the heat radiation plate 76.

As shown in FIG. 5, the front wheel drive motor controller 70 includes an inverter circuit (not shown) which converts DC power (e.g., 48V) supplied from the battery unit 34 into AC power, and the AC power supplied from the front wheel drive motor 54 into DC power (e.g., 48V), and a control circuit (not shown) for controlling the magnitude or the like of the AC power. The DC plus terminal (P) of the front wheel drive motor controller 70 is coupled to the plus terminal (P) of the battery unit 34 via a contactor 71 and a wire 80a. The DC minus terminal (N) of the front wheel drive motor controller 70 is coupled to the minus terminal (N) of the battery unit 34 via a wire 80b, a collective terminal 78 and a wire 80c. The AC terminal of the front wheel drive motor controller 70 is coupled to the front wheel drive motor 54 via a wire 80d. The contactor 71 is capable of switching between connection and disconnection of an electric circuit for supplying the electric power. In the present embodiment, the electric power supply is enabled when the key switch 50 (FIG. 1) is ON, while the electric power supply is inhibited when the key switch 50 (FIG. 1) is OFF.

As shown in FIGS. 6 and 7, the front wheel drive motor controller 70 has a block-like casing 82 having a substantially flat lower surface 82a. A side portion 82b of the casing 82, which faces inside of the engine room R, is provided with a plurality of terminals 82c coupled to the wires 80a and 80b, and others (FIG. 5).

Referring to FIG. 5, the rear wheel drive motor controller 72 includes an inverter circuit (not shown) which converts DC power (e.g., 48V) supplied from the battery unit 34 into AC power, and converts AC power supplied from the rear wheel drive motor 58 into DC power (e.g., 48V), and a control circuit (not shown) for controlling the magnitude of the AC power, or the like. The DC plus terminal (P) of the rear wheel drive motor controller 72 is coupled to the plus terminal (P) of the battery unit 34 via a contactor 73 and a wire 80a. The DC minus terminal (N) of the rear wheel drive motor controller 72 is coupled to the minus terminal (N) of the battery unit 34 via a wire 80b, the collective terminal 78 and a wire 80c. The AC terminal of the rear wheel drive motor controller 72 is coupled to the rear wheel drive motor 58 via a wire 80e. The contactor 73 is capable of switching between connection and disconnection of an electric circuit for supplying the electric power. In the present embodiment, the electric power supply is enabled when the key switch 50 (FIG. 1) is ON, while the electric power supply is inhibited when the key switch 50 (FIG. 1) is OFF.

As shown in FIGS. 6 and 7, the rear wheel drive motor controller 72 has a block-like casing 84 having a substantially flat lower surface 84a. A side portion 84b of the casing 84, which faces the inside of the engine room R, is provided with a plurality of terminals 84c coupled to the wires 80a and 80b, and others (FIG. 5).

Referring to FIG. 5, the electric generator controller 74 includes an inverter circuit (not shown) which converts the DC power (e.g., 48V) supplied from the battery unit 34 into AC power, and converts AC power supplied from the engine electric generator 62 into DC power (e.g., 48V), and a control circuit (not shown) for controlling the engine electric generator 62. The DC plus terminal (P) of the electric generator controller 74 is coupled to the plus terminal (P) of the battery unit 34 via a contactor 75 and a wire 80a. The DC minus terminal (N) of the electric generator controller 74 is coupled to the minus terminal (N) of the battery unit 34 via a wire 80b, the collective terminal 78 and a wire 80c. The AC terminal of the electric generator controller 74 is coupled to the engine electric generator 62 via a wire 80f. The contactor 75 is capable of switching between connection and disconnection of an electric circuit for supplying the electric power, and is controlled by a control circuit (not shown) of the electric generator controller 74.

As shown in FIGS. 6 and 8, the electric generator controller 74 has a block-like casing 86 provided with a plurality of fins 86a on a surface thereof. A side portion of the casing 86 is provided with a plurality of terminals 86b coupled to the wires 80a and 80b, and others (FIG. 5). The casing 86 is provided with a plurality of (in the present embodiment, four) mounting elements 86d having holes (not shown) into which bolts 86c are inserted, respectively. A substantially tubular spacer 86e is provided around the outer periphery of each of the bolts 86c inserted into the holes (not shown) of the mounting elements 86d to ensure a space Q (FIG. 8) between the casing 86 and the heat radiation plate 76.

As shown in FIG. 6, the heat radiation plate 76 is configured to support the front wheel drive motor controller 70, the rear wheel drive motor controller 72, and the electric generator controller 74. In addition, the heat radiation plate 76 is configured to store heat generated in these electric components and radiate the heat from its outer surface. The heat radiation plate 76 is formed by bending a single metal-made plate member. As a material used for the heat radiation plate 76, metal capable of storing heat and radiating the heat from its outer surface is preferably used. Among metals, aluminum alloy or copper is preferably used, because they have a high anti-corrosion property. Particularly, aluminum alloy is preferably used, because it is lightweight. In the present embodiment, as the material of the heat radiation plate 76, aluminum alloy is used. The heat radiation plate 76 is designed to have a heat capacity of 2.5˜3.5 [degrees C./W] as a whole.

As shown in FIG. 6, the heat radiation plate 76 includes a flat plate portion 88, four reinforcement portions 90a, 90b, 90c, and 90d for reinforcing the flat plate portion 88, and three engagement elements 92a, 92b and 92c engaged with the cross member 30 of the vehicle body frame 12 from above. The heat radiation plate 76 is mounted to the vehicle body frame 12 using a plurality of (in the present embodiment, seven) coupling mechanisms 94.

As shown in FIG. 6, the flat plate portion 88 has a substantially plate shape and supports the front wheel drive motor controller 70, the rear wheel drive motor controller 72, the electric generator controller 74 and the collective terminal 78. The flat plate portion 88 has a substantially rectangular shape elongated in the forward and rearward direction when viewed from above. The flat plate portion 88 has obverse and reverse flat surfaces. Electric component mounting sections 88c are provided in a part of the obverse surface, which is an upper surface 88b. The front wheel drive motor controller 70 and the rear wheel drive motor controller 72 are mounted to the electric component mounting sections 88c, respectively. The length of the flat plate portion 88 in the forward and rearward direction is set greater than a sum of the length the front wheel drive motor controller 70, the length of the collective terminal 78, and the length of the rear wheel drive motor controller 72, in the forward and rearward direction, in a state where the front wheel drive motor controller 70, the collective terminal 78, and the rear wheel drive motor controller 72 are arranged in the forward and rearward direction. Also, the length of the flat plate portion 88 is smaller than a distance between the two cross members 30. The length of the flat plate portion 88 in the rightward and leftward direction is set greater than the length of one of the front wheel drive motor controller 70, the rear wheel drive motor controller 72, the electric generator controller 74, and the collective terminal 78 which is the longest in the rightward and leftward direction. In other words, the upper surface (obverse surface) 88b of the flat plate portion 88 on which the electric components are provided is much greater in area than a sum of the two electric component mounting sections 88c to which the electric components (the front wheel drive motor controller 70 and the rear wheel drive motor controller 72) are mounted. The flat plate portion 88 has a plurality of holes 88a into which bolts (not shown) are inserted to mount the front wheel drive motor controller 70, the rear wheel drive motor controller 72, the electric generator controller 74 and the collective terminal 78, to the flat plate portion 88.

As shown in FIG. 6, the first reinforcement portion 90a has a substantially plate shape and extends upward from the front edge of the flat plate portion 88 via a first bent portion 89a bent at approximately 90 degrees. The first engagement element 92a of a substantially plate shape which is engageable with the cross member 30 and the second engagement element 92b of a substantially plate shape which is engageable with the cross member 30 extend forward from the upper edge of the first reinforcement portion 90a such that the first engagement element 92a and the second engagement element 92b are spaced apart from each other in the rightward and leftward direction. As shown in FIG. 9, each of the first engagement element 92a (FIGS. 9, 7) and the second engagement element 92b (FIG. 7) has a hole 96 into which a bolt 100 constituting the coupling mechanism 94 is inserted.

As shown in FIG. 6, the second reinforcement portion 90b has a substantially plate shape and extends upward from the rear edge of the flat plate portion 88 via a second bent portion 89b bent at approximately 90 degrees. The third engagement element 92c of a substantially plate shape which is engageable with the cross member 30 extends rearward from the upper edge of the second reinforcement portion 90b. The third engagement element 92c has a hole similar to the hole 96 (FIG. 9).

As shown in FIG. 6, the third reinforcement portion 90c has a substantially plate shape and extends upward from the right edge of the flat plate portion 88 via a third bent portion 89c bent at approximately 90 degrees. The contactors 71, 73, and 75 are coupled to the outer surface of the third reinforcement portion 90c by means of bolts and others. The vertical length of a portion of the third reinforcement portion 90c which faces the front wheel drive motor controller 70 and the vertical length of a portion of the third reinforcement portion 90c which faces the rear wheel drive motor controller 72 are each set substantially equal to the vertical length of the side portion 82b of the front wheel drive motor controller 70 and the vertical length of the side portion 84b of the rear wheel drive motor controller 72. Therefore, the wires 80a and 80b, and others (FIG. 5) connected to the terminals 82c and 84c provided on the side portions 82b and 84b, respectively, are not strongly pressed by the upper edge of the third reinforcement portion 90c.

As shown in FIG. 6, the fourth reinforcement portion 90d has a substantially plate shape and extends upward from the left edge of the flat plate portion 88 via a fourth bent portion 89d bent at approximately 90 degrees. The fourth reinforcement portion 90d is coupled to the side surface of the rear side frame 28 by using a plurality of (in the present embodiment, three) coupling mechanisms 94. The fourth reinforcement portion 90d has holes (not shown) similar to the hole 96 (FIG. 9) formed in the first engagement element 92a.

As shown in FIG. 9, each of the plurality of coupling mechanisms 94 includes the bolt 100, a nut 102 threadingly engaged with the bolt 100, an insulating member 104 and a sleeve 106. The coupling mechanism 94 corresponding to each of the engagement elements 92a, 92b and 92c has a base member 108 which constitutes a portion of the cross member 30. The insulating member 104 includes a tubular portion 104a of a substantially tubular shape which is disposed on the inner peripheral surface of the hole 96, a first flange portion 104b provided at one end portion of the tubular portion 104a in a lengthwise direction thereof, and a second flange portion 104c provided at an opposite end portion of the tubular portion 104a in the lengthwise direction thereof. The tubular portion 104a, the first flange portion 104b and the second flange portion 104c have a unitary structure using an insulating material such as rubber. The tubular portion 104a provides insulativity between the heat radiation plate 76 and the sleeve 106. The first flange portion 104b provides insulativity between the heat radiation plate 76 and a head portion 100a of the bolt 100. The second flange portion 104c provides insulativity between the heat radiation plate 76 and the cross member 30.

As shown in FIG. 9, the sleeve 106 has a substantially tubular shape and is made of metal, plastic, or the like. The sleeve 106 serves to prevent the insulating member 104 from being deformed excessively. The length of the sleeve 106 is set substantially equal to or smaller than the length of the tubular portion 104a. The inner diameter of the sleeve 106 is set greater than the outer diameter of a male thread portion 100b of the bolt 100, while the outer diameter of the sleeve 106 is set substantially equal to the inner diameter of the tubular portion 104a.

As shown in FIG. 9, the base member 108 is a portion of the cross member 30 and supports the engagement element 92a. The base member 108 includes a support portion 108a of a substantially plate shape, and two leg portions 108b and 108c extending downward from both ends of the support portion 108a in the forward and rearward direction. The lower end portion of the leg portion 108b and the lower end portion of the leg portion 108c are coupled to the cross member 30 by welding, or the like. The support portion 108a has a hole 108d into which the bolt 100 is inserted. The coupling mechanism 94 for coupling the fourth reinforcement portion 90d (FIG. 6) to the side surface of the rear side frame 28 allows the nut 102 to be directly engaged with the rear side frame 28. Therefore, the base member 108 (FIG. 9) need not be provided on the side surface of the rear side frame 28.

As shown in FIG. 9, when the heat radiation plate 76 is coupled to the vehicle body frame 12 using the coupling mechanisms 94, firstly, the two leg portions 108b and 108c of each of the base members 108 are coupled to the upper portion of the cross member 30, by welding or the like. And, the insulating members 104 are attached to the holes 96 and other holes (not shown) formed in the heat radiation plate 76, and the sleeves 106 are disposed on the inner peripheral surfaces of the tubular portions 104a of the insulating members 104. The sleeves 106 of the plurality of coupling mechanisms 94 are positioned with respect to the holes 108d of the base members 108 or the holes (not shown) formed in the side surface of the rear side frame 28, and the male thread portions 100b of the bolts 100 are inserted into these holes and the sleeves 106. Thereafter, the nuts 102 are threadingly engaged with the tip end portions of the male thread portions 100b.

As shown in FIG. 6, in a state where the heat radiation plate 76 is coupled to the vehicle body frame 12, the heat radiation plate 76 is positioned at one side end portion of the vehicle body frame 12 in the vehicle width direction to extend in the forward and rearward direction. The fourth reinforcement portion 90d is positioned below the upper end of the rear side frame 28. The fourth reinforcement portion 90d is coupled to the side surface of the vehicle body frame 12 below the upper end of a portion of the vehicle body frame 12 which corresponds to the fourth reinforcement portion 90d. The flat plate portion 88 extends substantially horizontally along the side surface of the rear side frame 28. The front wheel drive motor controller 70 and the rear wheel drive motor controller 72 are arranged side by side on the upper surface (obverse surface) 88b of the flat plate portion 88 in the forward and rearward direction, while the electric generator controller 74 is positioned on the center portion of the lower surface (reverse surface) (not shown) of the flat plate portion 88 in the forward and rearward direction.

As shown in FIG. 6, when the front wheel drive motor controller 70 is mounted to the heat radiation plate 76, the lower surface 82a of the casing 82 is brought into contact with the electric component mounting section 88c of the upper surface 88b of the flat plate portion 88, and the casing 82 is coupled to the flat plate portion 88. In this state, the casing 82 is coupled to the flat plate portion 88 by means of bolts and nuts (not shown). When the rear wheel drive motor controller 72 is mounted to the heat radiation plate 76, the lower surface 84a of the casing 84 is brought into contact with the electric component mounting section 88c of the upper surface 88b of the flat plate portion 88, and the casing 84 is coupled to the flat plate portion 88. In this state, the casing 84 is coupled to the flat plate portion 88 by means of bolts and nuts (not shown). When the electric generator controller 74 is mounted to the heat radiation plate 76, the upper end surface of the spacer 86e is brought into contact with the lower surface (reverse surface) (not shown) of the flat plate portion 88, and the casing 86 is coupled to the flat plate portion 88 by means of the bolts and nuts (not shown).

Referring to FIG. 5, to start-up the hybrid vehicle 10, the driver turns ON the key switch 50 (FIG. 1), thereby allowing the contactors 71 and 73 to supply the electric power. Then, the front wheel drive motor controller 70 converts the DC power of the battery unit 34 into AC power, which actuates the front wheel drive motor 54. Also, the rear wheel drive motor controller 72 converts the DC power of the battery unit 34 into AC power, which actuates the rear wheel drive motor 58. When the value of SOC (state of charge) of the battery unit 34 decreases to a value less than a predetermined value with a passage of a driving time of the hybrid vehicle 10, the electric generator 62a of the engine electric generator 62 starts the engine 62b by the driver's operation or automatically. Then, the engine 62b actuates the electric generator 62a to generate AC power. The electric generator controller 74 converts the AC power generated in the electric generator 62a into DC power, which is charged into the battery unit 34. In the case where the front wheel drive motor 54 and the rear wheel drive motor 58 operate as regenerative brakes, the AC power generated in the front wheel drive motor 54 is converted into DC power by the front wheel drive motor controller 70 and the AC power generated in the rear wheel drive motor 58 is converted into DC power by the rear wheel drive motor controller 72. DC power is charged into the battery unit 34. In the front wheel drive motor controller 70, the rear wheel drive motor controller 72, and the electric generator controller 74, inverter circuits and the like (not shown) built in these controllers generate heat. This heat is transferred to the heat radiation plate 76 and stored therein. And, the heat is radiated from the entire surface of the heat radiation plate 76.

In accordance with the hybrid vehicle 10 of the present embodiment configured above, the follow advantages are achieved.

As shown in FIG. 7, since the two electric components, i.e., the front wheel drive motor controller 70 and the rear wheel drive motor controller 72 are mounted to the surface of the flat plate portion 88 in a state where the front wheel drive motor controller 70 and the rear wheel drive motor controller 72 are thermally coupled to the flat plate portion 88, heat generated in these electric components is transferred from the flat plate portion 88 to the entire heat radiation plate 76 and stored therein. Since the area of the surface of the flat plate portion 88 is much greater than a sum of the areas of the two electric component mounting sections 88c to which the two electric components are mounted, respectively, heat stored inside the flat plate portion 88 can be radiated efficiently from the upper surface (obverse surface) 88b and the lower surface (reverse surface) (not shown) of the flat plate portion 88.

As shown in FIG. 7, since the obverse and reverse surfaces of the flat plate portion 88 are flat, mobility of air in the vicinity of the flat plate portion 88 can be enhanced, and hence the heat can be radiated more effectively, as compared to a plate provided with a plurality of fins. In addition, since there is no unevenness on the surface of the flat plate portion 88, mud or the like is less likely to adhere to dented portions of the unevenness.

As shown in FIG. 2, the heat radiation plate 76 is deviated in the vehicle width direction from the engine 62b. The two electric components, i.e., the front wheel drive motor controller 70 and the rear wheel drive motor controller 72 are arranged in the forward and rearward direction on the heat radiation plate 76. Because of this layout, these electric components are not heated by heat generated in the engine 62b. Heat generated in the engine 62b tends to be transferred in a rearward direction. Since the heat radiation plate 76 is positioned outside a path through which the heat generated in the engine 62b is transferred, the electric components are not heated by the heat.

As shown in FIG. 4, the heat radiation plate 76 and the three electric components (FIG. 6) are arranged in a space below the cargo bed 42 (FIG. 1) behind the driver seat 18a, i.e, the engine room R. Therefore, these electric components (FIG. 6) can be cooled effectively and efficiently, by, for example, the air flowing into the engine room R through a space between the cargo bed 42 (FIG. 12) and the vehicle body frame 12. In addition, below the cargo bed 42 (FIG. 1), a wide space can be ensured. Therefore, the size of the heat radiation plate 76 can be increased so that the electric components can be cooled more effectively.

Referring to FIG. 5, the time periods for which the three electric components mounted to the heat radiation plate 76 are activated and are generating heat do not always match. Therefore, when a particular electric component is not generating heat, heat generated in another electric components can be radiated efficiently from the entire heat radiation plate 76. For example, when the rear wheel drive motor controller 72 is activated, but the front wheel drive motor controller 70 and the electric generator controller 74 are deactivated, the heat generated in the rear wheel drive motor controller 72 can be radiated efficiently from the entire heat radiation plate 76.

As shown in FIG. 8, the space Q can be provided between the casing 86 of the electric generator controller 74 and the heat radiation plate 76. Air flowing through the space Q can efficiently diffuse the heat generated in the electric generator controller 74. During a stopped state of the hybrid vehicle 10, air tends to be stagnant in the space Q. In that case, a part of the heat generated in the electric generator controller 74 can be transferred to the heat radiation plate 76 via the stagnant air, and as a result, the heat can be radiated from the heat radiation plate 76.

As shown in FIGS. 6 and 7, the three electric components, i.e., the front wheel drive motor controller 70, the rear wheel drive motor controller 72, and the electric generator controller 74 can be supported on the heat radiation plate 76 which is a single plate. Therefore, support members (not shown) for supporting these electric components need not be provided separately, and the number of steps for manufacturing the hybrid vehicle 10 can be reduced. In addition, the heat radiation plate 76 can be mounted to or detached from the vehicle body frame 12 in the state where the three electric components are coupled to the heat radiation plate 76. Thus, maintenance can be carried out easily.

As shown in FIG. 6, since the front wheel drive motor controller 70 and the rear wheel drive motor controller 72 are placed on the upper side of the flat plate portion 88 and the electric generator controller 74 is placed on the lower side of the flat plate portion 88, compact layout of these components is achieved.

As shown in FIG. 4, since the heat radiation plate 76 is mounted to the side surface of the rear side frame 28 located above the main frame 22, muddy water, debris, and the like, flying from the rear wheel 16 of the hybrid vehicle 10, during driving, are less likely to contact the heat radiation plate 76. Also, the heat radiation plate 76 is less likely to be affected by some obstacles, during driving of the hybrid vehicle 10.

As shown in FIG. 6, the fourth reinforcement portion 90d of the heat radiation plate 76 is coupled to the side surface of the rear side frame 28 in a location below the upper end of the rear side frame 28 constituting the vehicle body frame 12. Therefore, it is possible to prevent the heat radiation plate 76 from protruding upward from the upper surface of the rear side frame 28, and hence interfering with the cargo bed 42 (FIG. 1).

As shown in FIG. 5, the DC minus terminal (N) of the front wheel drive motor controller 70, the DC minus terminal (N) of the rear wheel drive motor controller 72, and the DC minus terminal (N) of the electric generator controller 74 are connected to the collective terminal 78 via the wires 80b. In this way, the layout of the wires 80b is simplified. Also, as shown in FIG. 4, since a portion of the rear wheel drive motor 58 is positioned below the heat radiation plate 76, and a distance between the rear wheel drive motor 58 and the rear wheel drive motor controller 72 is short, the length of the wire 80e (FIG. 5) can be reduced. This makes it possible to reduce the overall length of a wire harness (not shown) constituting the wires 80b and 80e, etc. (FIG. 5). As a result, cost reduction can be achieved, and a possibility of radio disturbance can be lessened.

Referring to FIG. 9, since the heat radiation plate 76 and the vehicle body frame 12 are electrically insulated from each other by the insulating members 104 made of rubber or the like, the vehicle body frame 12 can be prevented from being electrically charged, even if the heat radiation plate 76 is electrically charged. Because of this, even in a configuration in which a body earth line of an electric component other than the above stated electric components is connected to the vehicle body frame 12, the operation of this electric component can be stabilized.

Referring to FIG. 9, since a vibration transmitted from the vehicle body frame 12 to the heat radiation plate 76 can be absorbed by the insulating members 104 made of rubber or the like, the electric components mounted to the flat plate portion 88 can be protected by the vibration.

As shown in FIG. 5, in the present embodiment, the present invention is applied to the four-wheeled utility vehicle. In alternative embodiment, the present invention may be applied to other hybrid vehicles such as ATVs (all terrain vehicles), two-wheeled vehicles, or three-wheeled vehicles. In the present embodiment, the present invention is applied to the series hybrid vehicle 10. In alternative embodiment, the present invention may be applied to hybrid vehicles such as parallel hybrid vehicles, or series-parallel hybrid vehicles. In further alternative embodiment, the present invention may be applied to a hybrid vehicle in which either the front wheels 14 or the rear wheels 16 are drive wheels.

As shown in FIG. 5, in the present embodiment, the single front wheel drive motor 54 is provided for the front wheels 14 and the single rear wheel drive motor 58 is provided for the rear wheels 16. In another embodiment, a plurality of drive motors (not shown) may be provided for at least either the front wheels 14 or the rear wheels 16. In the case of using three or more drive motors, three or more drive motor controllers may be provided to correspond to these drive motors, respectively, and these drive motor controllers may be mounted to a single heat radiation plate.

As shown in FIG. 6, in the present embodiment, the front wheel drive motor controller 70 is placed on the front portion of the upper surface of the heat radiation plate 76, the rear wheel drive motor controller 72 is placed on the rear portion of the upper surface, and the electric generator controller 74 is placed on the center portion of the lower surface in the forward and rearward direction. In alternative embodiment, the positional relation of these electric components on the upper and lower surfaces may be reversed. For example, the relation may be reversed between the position of the electric generator controller 74, and either one of the position of the front wheel drive motor controller 70 and the position of the rear wheel drive motor controller 72.

Moreover, in alternative embodiment, another kinds of electric components may be mounted to the heat radiation plate 76, in addition to or instead of the front wheel drive motor controller 70, the rear wheel drive motor controller 72, and the electric generator controller 74.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A hybrid vehicle comprising:
a vehicle body frame;
a metal-made heat radiation plate having a flat plate portion of a substantially plate shape, the flat plate portion having obverse and reverse flat surfaces;
a first electric component provided on one of the obverse and reverse flat surfaces of the flat plate portion; and
the surface of the flat plate portion on which the first electric component is provided, is greater in area than an electric component mounting section to which the first electric component is mounted.

2. The hybrid vehicle according to claim 1,
wherein the heat radiation plate is positioned at one side end portion of the vehicle body frame in a vehicle width direction to extend in a forward and rearward direction.

3. The hybrid vehicle according to claim 1, further comprising:
a cargo bed;
wherein the heat radiation plate is positioned below the cargo bed.

4. The hybrid vehicle according to claim 1,
wherein the heat radiation plate has a reinforcement portion of a substantially plate shape on an edge of the flat plate portion via a bent portion; and
the reinforcement portion is coupled to a side surface of the vehicle body frame in a location below an upper end of a portion of the vehicle body frame which corresponds to the reinforcement portion.

5. The hybrid vehicle according to claim 1, further comprising:
drive wheels suspended from the vehicle body frame; and
a plurality of drive motors for driving the drive wheels;
the first electric component includes a plurality of first electric components corresponding to the plurality of drive motors, respectively; and
the plurality of first electric components are mounted to the flat plate portion of the heat radiation plate which is a single plate.

6. The hybrid vehicle according to claim 1, further comprising:
a drive motor;
a battery for supplying electric power to the drive motor;
an engine electric generator including an electric generator for generating electric power charged into the battery and an engine for actuating the electric generator; and
a second electric component for controlling the engine electric generator;
wherein the second electric component is supported on the flat plate portion.

7. The hybrid vehicle according to claim 1,
wherein the heat radiation plate is positioned at one side end portion of the vehicle body frame in a vehicle width direction to extend in a forward and rearward direction;
and a plurality of electric components including the first electric component are mounted to the flat plate portion such that the plurality of electric components are arranged side by side in the forward and rearward direction.

8. The hybrid vehicle according to claim 1,
wherein the heat radiation plate is mounted to the vehicle body frame via an insulating member.

9. The hybrid vehicle according to claim 6,
wherein the flat plate portion extends horizontally;
the first electric component is placed on an upper side of the flat plate portion; and
the second electric component is placed on a lower side of the flat plate portion.

10. The hybrid vehicle according to claim 6,
the heat radiation plate is deviated in a vehicle width direction from the engine.

11. The hybrid vehicle according to claim 1,
wherein the heat radiation plate is made of aluminum alloy.
